(19) United States
(12) Patent Application Publication
(10) Pub. No.: US 2007/0136476 A1
(43) Pub. Date: Jun. 14, 2007

(54) Controlled peer-to-peer network

(76) Inventor: Isaac Rubinstein, Haworth, NJ (US)

Correspondence Address: Russ Weinzimmer, 614 Nashua St. #204, Milford, NH, 03055, US

(21) Appl. No.: 11/299,432

(22) Filed: Dec. 12, 2005

(51) Int. Cl. G06F 15/16

(52) U.S. Cl. 709/227

(57) ABSTRACT

An internet broadcast system is provided that uses a fixed amount of bandwidth, making low fixed demands on broadcast server resources, regardless of the number of recipients. The system can provide content authentication, source authentication, a clear path to the source of intellectual property rights abuse, and reduced security vulnerability of local content, and enables clients receiving streamed content from a server to communicate back to the server using content-sensitive “user experience elements”. The apparatus includes a network management center that receives connection information requests from the plurality of clients, providing connection information to at least one of the plurality of clients; and includes a broadcast center that receives the connection information, and provides the signal. The broadcast center receives a connection request, and also provides the signal only after receiving the connection request, and then uses the connection request with the connection information to provide the signal.

### FIELD OF THE INVENTION

This invention relates to broadcasting digital information, and particularly relates to broadcasting digital information via a network.

### BACKGROUND OF THE INVENTION

Radio stations, record labels, music-related websites, news websites, entertainment websites, and many others, stream audio and video information over the Internet. They all face similar problems, however, because bandwidth requirements and server processing power requirements each depend on the number of simultaneous recipients of the streaming information. Since each recipient receives a separate data stream, the total processing and bandwidth requirements are proportional to the number of simultaneous recipients. Exhausted infrastructure leads to rising broadcast costs to upgrade the infrastructure, while failing to upgrade the infrastructure as needed results in diminishing listener experience and increasing service interruptions. Currently, the common way to overcome server overload-related problems and network infrastructure overload-related problems is to spend excessive amounts of scarce financial resources so as to increase the capacity of the servers and the network infrastructure.

One attempt to address this problem is to implement “multicasting”—a technology that enables streaming of a single stream of information to many recipients. However, most networks block multicasting. Further, the Multicast model requires a great deal more state inside the network than required by the standard IP model of best-effort delivery. Also, the Multicast model introduces numerous spam opportunities. Moreover, no mechanism is yet available to allow the IP Multicast model to practically scale to millions of senders and receivers. In addition, the networking technology community strongly opposes Multicasting, mainly because Multicasting requires opening firewalls to broadcasts that can flood an entire network with unsolicited traffic.

Alternatively, “peer-to-peer” networks have been applied in an attempt to address the server processing and bandwidth capacity problems. Although appearing technically feasible, the uncontrolled nature of a typical peer-to-peer solution introduces serious network-related and content-related issues when applied to the problem of server processing limitations and bandwidth limitations when broadcasting digital information over a network, the issues including:

Content authentication: there is no guarantee of the legitimacy or authenticity of the information content received by a listener, a viewer, or other streaming data consumer. Any node in the peer-to-peer network can alter or completely substitute any content element.

Source authentication: a new node (a new member, a new streaming data consumer, etc.) of a network has no guarantee that he/she is actually connecting to a legitimate source. There is no way to authenticate the source or to differentiate between legitimate an illegitimate sources.

Intellectual property rights protection: traditional peer-to-peer networks do not possess features that help to address the need to protect the intellectual property rights of streaming content providers. Since any node can share data with any other node on the network, there is no authenticated source, and consequently there is no path of responsibility for purposes of accountability. Sometimes, the content itself embeds intellectual rights protection tools, by means of encryption or similar mathematical techniques, for example. Nevertheless, once a single hacker manages to bypass such protection tools, an unprotected version of the content, such as a song or a movie, can freely spread over the peer-to-peer network, thereby jeopardizing the intellectual property rights of the content owner. In addition, any participant in a peer-to-peer network could unknowingly distribute copyrighted materials, and thereby inadvertently become exposed to legal liability for intellectual property rights infringement.

Security: peer-to-peer network clients share data files stored on their own storage device with other nodes of the same network, leaving each client vulnerable. A “battle of the minds” ensues between the writers of the peer-to-peer software and malicious “hackers”. Every time a hacker discovers a new network vulnerability, all nodes of the network become exposed.

Currently, all available audio or video network data streaming solutions are unidirectional. The streaming server streams content to the clients, and the clients simply receive. There is no interaction between the receiving client and the server. Clients have no means of providing feedback to the server as to the content they receive.

### SUMMARY OF THE INVENTION

The invention provides an internet broadcast system that uses a fixed amount of bandwidth, and that makes fixed and low demands upon broadcast server resources, regardless of the number of recipients. The invention also addresses the problematic issues of a traditional “peer-to-peer” solution, such as content authentication, source authentication, lack of clear path to the source of intellectual property rights abuse, and security vulnerabilities due to exposure of local content.

Some embodiments of the invention enable clients receiving streamed content from a server to communicate back to the server using content-sensitive “user experience elements” such as radio-buttons, drop down lists, customizable buttons, and URLs, for example. The content provider, in synchronization with the actual streamed content, can change these user experience elements as appropriate to the streamed content. For example, a URL pointing to a songwriter's website can be made visible while a song is playing. A purchase button can appear while an advertisement airs. If a user clicks on such a button, a browser pointing to a site selling the advertised product will open.

As another example, a listener can express an opinion about a song or any other matter discussed by selecting from a customized set of options relevant to the topic. The options change as the topics or music change.

Controlled peer-to-peer (CP2P) networks are useful in areas other than audio or video streaming. They can be used in any application that requires streaming of a signal to a multitude of recipients. Even when the signal is encapsulated, such as when the signal represents a data file, the signal can still be delimited and then streamed over a Controlled P2P network to multiple recipients.

The CP2P network of the invention is also useful for when a file or a security patch needs to be distributed to a large number of computers, and bandwidth availability is a problem, such as sometimes happens in corporate environments. The CP2P network of the invention can help distribute files while conserving bandwidth and server processing resources. By delimiting streaming data, files can be transferred using the CP2P of the invention. To provide file content integrity, it is advantageous to provide content integrity verification, such as by using SHA-1 hash to verify file integrity at the end of a transmission.

Another use of the invention is “site content pumping”, wherein it is possible to link all viewers of a website into a website-specific or web-page-specific CP2P channel, thereby providing active website content updates. For example, in a dynamic website according to the invention, a web page can automatically refresh on a visitor's browser, whenever underlying conditions on the web server change. An example of site content pumping is an airline website, or concert ticketing site, that automatically provides updates to all of its current website visitors whenever the status of a flight changes, or when a concert is canceled, without requiring any user action.

In a general aspect of the invention, an apparatus is provided for broadcasting a signal to lity of clients. The apparatus includes a network management center configured to receive connection information requests from the plurality of clients, and to provide connection information to at least one of the plurality of clients; and a broadcast center, cooperative with the network management center, configured to receive the connection information, and to provide the signal.

In a preferred embodiment, the broadcast center is also configured to receive a connection request, and is also configured to provide the signal only after receiving the connection request, and then to use the connection request with the connection information to allow the signal to be provided. In a further preferred embodiment, the connection information request and the connection request originate from a first client.

In another preferred embodiment, the connection information request originates from a first client, which first client then receives connection information.

In yet another preferred embodiment, a first client is connected to the broadcast center and then receives a signal from the broadcast center, and wherein a second connection information request and a second connection request originate from a second client, the second client receiving the signal from the first client only after the first client receives the second connection request, the first client then using the second connection request with connection information provided by the network management center to allow the signal to be provided to the second client. In a further preferred embodiment, the second client is connected to the first client, and then receives a signal from the first client, and wherein a third connection information request and a third connection request originate from a third client, the third client receiving the signal from the second client only after the second client receives the third connection request, the second client then using the third connection request with connection information provided by the network management center to allow the signal to be provided to the third client.

In yet another preferred embodiment, the broadcast center provides the signal to a first client, and the first client is capable of providing the signal to more than one client.

In still another preferred embodiment, the broadcast center provides the signal to a plurality of clients, the plurality of clients being connected as at least one tree structure, the broadcast center providing the signal directly to each client that serves as the root of a tree structure. In a further preferred embodiment, the tree structure is divided into a plurality of IPP ranges. In another preferred embodiment, the plurality of clients includes clients capable of transmitting the signal to a number of clients, the number being limited by at least one of the data transmission capacity and the processing capacity of each transmitting client. In yet a further preferred embodiment, each of the clients in the tree structure has joined the tree structure by communicating with the network management center.

In still further preferred embodiments, communicating with the network management center includes: a client sending a connection information request to the network management center; and the network management center providing connection information to the client.

In other preferred embodiments, each client communicates with the network management center only while joining the tree structure, and does not communicate with the network management center after joining the tree structure.

In some preferred embodiments, the signal includes a main stream channel and a control channel. In further preferred embodiments, when a client receives a control channel message via the control channel, if the control channel message includes a synchronous command, the client waits for a matching signal feature in the mainstream channel, whereupon the control channel message is passed to a control command processor for immediate processing. In other further preferred embodiments, when a client receives a control channel message via the control channel, if the control channel message includes an asynchronous command, the control channel message is passed to a control command processor for immediate processing.

In preferred embodiments, the broadcast center receives content from a content provider, and uses the content to provide the signal. In further preferred embodiments, the broadcast center provides an encrypted signal. In yet further preferred embodiments, the signal is encrypted using private/public key encryption. In some embodiments, the public key is provided with the signal so-encrypted.

In a preferred embodiment, an authorized recipient client decrypts the signal to reveal the content, and also provides the encrypted signal to at least one other authorized recipient client.

In some preferred embodiments, the apparatus of the invention includes a key management center, cooperative with the broadcast center, the key management center including: a channel key generator; a channel key repository; and a channel key distribution engine. In a further preferred embodiment, the broadcast center receives a channel key from the key management center, and uses the channel key to encrypt the signal to provide an encrypted signal. In a yet further preferred embodiment, an authorized recipient client receives a channel key from the key management center, and uses the channel key to decrypt the encrypted signal. In a still further preferred embodiment, each authorized recipient client receives the channel key from the key management center.

In some preferred embodiments, the broadcast center encrypts the signal using a channel key to provide an encrypted signal, and the broadcast center uses a private key to provide a signed message hash. In a further preferred embodiment, an authorized recipient client receives the encrypted signal and the signed message hash, and uses a channel key to provide a decrypted signal, and uses the decrypted signal, the signed message hash, and a public key to determine whether message content of the decrypted signal is valid.

In some preferred embodiments, when a client within a tree structure no longer receives a signal, but nevertheless provides a heart beat signal to a plurality of clients connected to the client, the heartbeat signal is used by the plurality of clients to remain connected to the client.

In other preferred embodiments, the main stream channel and the control channel are received by a client, the client including: a display manager configured to provide user experience elements; and a control command processor configured to provide display commands to the display manager, the user experience elements being acted upon by a user. In a further preferred embodiment, the user options acted upon by a user result in a communication as defined in the user options.

Another general aspect of the invention is a method for adding a client to a peer-to-peer network so as to add clients in a controlled manner. This method includes receiving, at a network management center, a connection information request from a requesting client; and sending, from the network management center, connection information to both the requesting client and a broadcasting client also as to facilitate communication between the broadcasting client and the requesting client, thereby adding the requesting client.

In a preferred embodiment, communication between the broadcasting client and the requesting client includes: sending a connection request from the requesting client to the broadcasting client; and sending a signal from the broadcasting client to the requesting client. In a preferred embodiment, the signal is at least one of a data stream and a data file. In another preferred embodiment, the signal is any information.

### BRIEF DESCRIPTION OF THE DRAWING

The invention will be more fully understood by reference to the detailed description, in conjunction with the following figures, wherein:

FIG. 1 is a schematic diagram showing a prior art network having a combined Network Management Center/Broadcast Center that receives a Connection Request from a first client and provides a signal to the first client;

FIG. 1A is a schematic diagram showing a prior art network having a combined Network Management Center/Broadcast Center connected to a first client that receives a Connection Request from a second client and provides a second signal to the second client;

FIG. 2 is a schematic diagram of an embodiment of the invention having a Network Management Center (NMC) and a Broadcast Center (BC), the diagram also showing how a first client communicates with both the NMC and the BC so as to join the controlled peer-to-peer network of the invention;

FIG. 2A is a schematic diagram of an embodiment of the invention having a Network Management Center (NMC) and a Broadcast Center (BC), the diagram also showing how a second client communicates with the NMC and the first client so as to join the controlled peer-to-peer network of the invention;

FIG. 3 is a schematic diagram of an embodiment of the invention having a Network Management Center (NMC) and a Broadcast Center (BC), the diagram also showing generally how an unconnected client communicates with the NMC and a connected client so as to join the controlled peer-to-peer network of the invention;

FIG. 4 is a schematic diagram of a Broadcast Center (BC) sending a signal to a plurality of clients connected to the BC, the plurality of clients also being partitioned into a plurality of IPP ranges based on IP Proximity;

FIG. 5 is a schematic diagram of a BC sending a signal to a plurality of clients connected to the BC, the plurality of clients being connected in a tree structure wherein each client can retransmit to a different number of new clients, the number based on the outgoing stream capacity of the transmitting client;

FIG. 5A is a schematic diagram of a first client being added to a CP2P network of the invention by communicating with a Network Management Center;

FIG. 5B is a schematic diagram of a second client being added to a CP2P network of the invention by communicating with a Network Management Center after the first client has communicated with the Network Management Center;

FIG. 5C is a schematic diagram of a third client being added to a CP2P network of the invention by communicating with a Network Management Center after the first and second clients have communicated with the Network Management Center;

FIG. 5D is a schematic diagram of a CP2P network of the invention having a plurality of clients connected in a tree structure and receiving a signal thereby from a Broadcast Center, each client being added sequentially by briefly communicating with a Network Management Center;

FIG. 6 is a schematic diagram of a Broadcast Center providing a signal to a plurality of clients, the clients being connected as a binary tree structure where each client has an outgoing stream capacity of two;

FIG. 7 is a schematic diagram of a Broadcast Center providing a signal to a plurality of clients, the clients being connected as a chain where each client has an outgoing stream capacity of one;

FIGS. 8, 8A, and 8B are a sequence of schematic diagrams that respectively illustrate a binary tree structure of clients, the binary tree structure after one client disconnects, a new binary tree structure reconfigured to provide a signal to all remaining clients;

FIG. 9 is a schematic diagram of Broadcast Center that incorporates standard private-public key encryption technology for transmitting an encrypted stream to two clients, including a public key if requested;

FIG. 10 is a schematic diagram of Broadcast Center that incorporates channel key encryption technology for transmitting an encrypted stream to two clients, the Broadcast Center and each client receiving a channel key from a key management center;

FIG. 11 is a schematic diagram of a Broadcast Center sending both a stream and a control channel signal to a plurality of clients;

FIG. 12 is a schematic diagram of a client receiving a stream and a control channel signal, the client including a control command processor for processing the control channel signal;

FIG. 13 is a schematic diagram of a Broadcast Center sending an encrypted stream and a signed hash signal to a client so as to perform stream authentication; and

FIG. 14 is a schematic diagram of how a control channel signal is used to create a synchronized reverse feed for gathering user feedback with a direct link to content.

### DETAILED DESCRIPTION

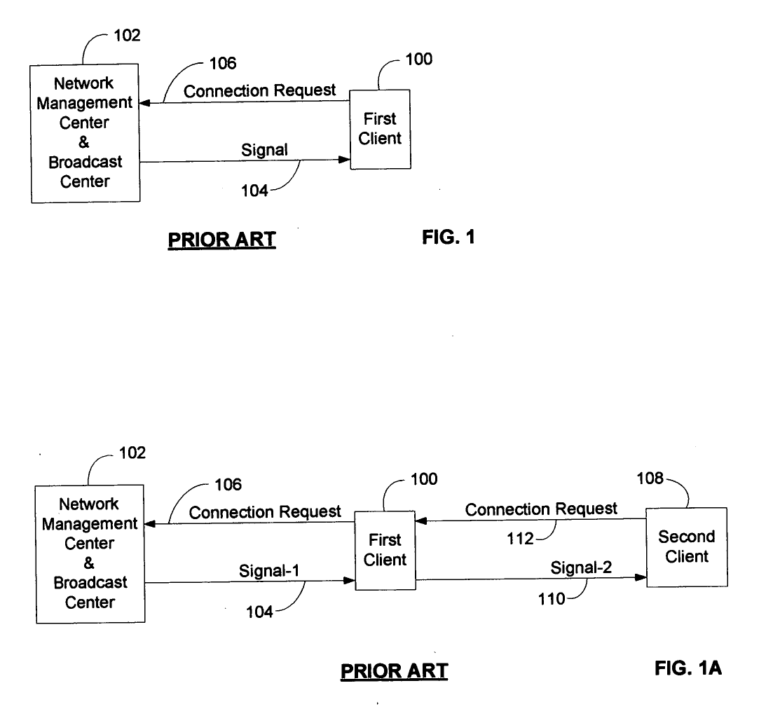

With reference to FIG. 1, in a prior art network, a first client 100 attempts to join the network controlled by a combined Network Management Center/Broadcast Center (NMC/BC) 102 so that the first client 100 can receive a signal 104 from the NMC/BC 102. First, the NMC/BC 102 receives a Connection Request 106 from the first client 100. In response, the first client 100 receives the signal 104. No connection information is sent over the network. Also, there is no connection information request sent over the network by the first client, or any subsequent client. Further, there's communication of connection information from the NMC/BC 102, and the first client 100, or any subsequent client.

With reference to FIG. 1A, in the prior art network of FIG. 1, a first client 100 has joined the network controlled by the combined Network Management Center/Broadcast Center (NMC/BC) 102 so that the first client 100 receives a signal-1 104 from the NMC/BC 102. A second client 108 attempts to join the network that now includes the first client 100 so that the second client 108 can receive the signal-2 110. Accordingly, the first client 100 receives a Connection Request 112 from the second client 108. In response, the first client 100 sends the signal-2 110 to the second client 108. Again, no connection information is sent over the network. Also, there is no connection information request sent over the network by the first client, or any subsequent client. Further, there's no communication of connection information from the NMC/BC 102, and the second client 108, or any subsequent client. Also notice that the signal Signal-1 104 received by the first client can be different from the signal Signal-2 110 received by the second client 108. This is because in the prior art network, there is no adequate way to address the issues of content authentication and/or source authentication.

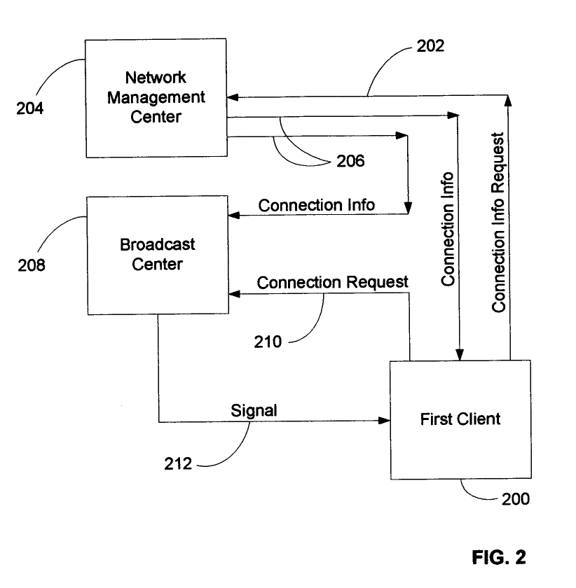

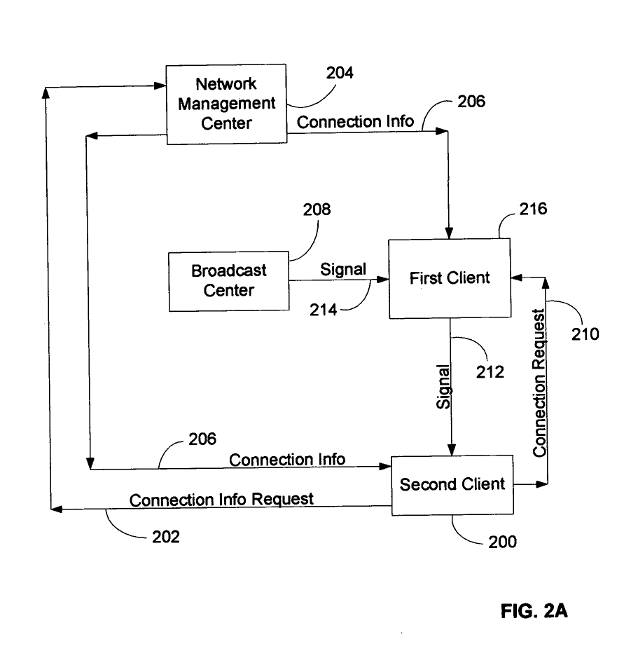

Referring to FIG. 2, by contrast, the controlled peer-to-peer network of the invention does not allow clients to connect to the network at will, just by making a connection request 106, 112. Instead, a first client 200 must initiate communication 202 first with a Network Management Center 204 that manages all client connections, the Network Management Center 204 only then sending connection information 206 to the first client 200, and to a separate Broadcast Center 208.

In particular, the first client 200 sends a Connection Info Request 202 to the Network Management Center 204. Network Management Center 204 then sends Connection Info 206 to the client 200 and to the Broadcast Center 208. Client 200 then sends a Connection Request 210 to the signal source as defined in Connection Info 206, which in this case is the Broadcast Center 208. The Broadcast Center 208 then starts sending the Signal 212 to the first client 200.

Referring to FIG. 2A, to add a second client 200, the second client 200 sends a Connection Info Request 202 to the Network Management Center 204. The Network Management Center 204 then sends Connection Info 206 to the second client 200 and to the first client 216. The second client 200 then sends a Connection Request 210 to the source as defined in Connection Info 206, which in this case is the first client 216. The first client 216 then starts sending the Signal 212, which is identical to the Signal 214 it is receiving from its source, the Broadcast Center 208.

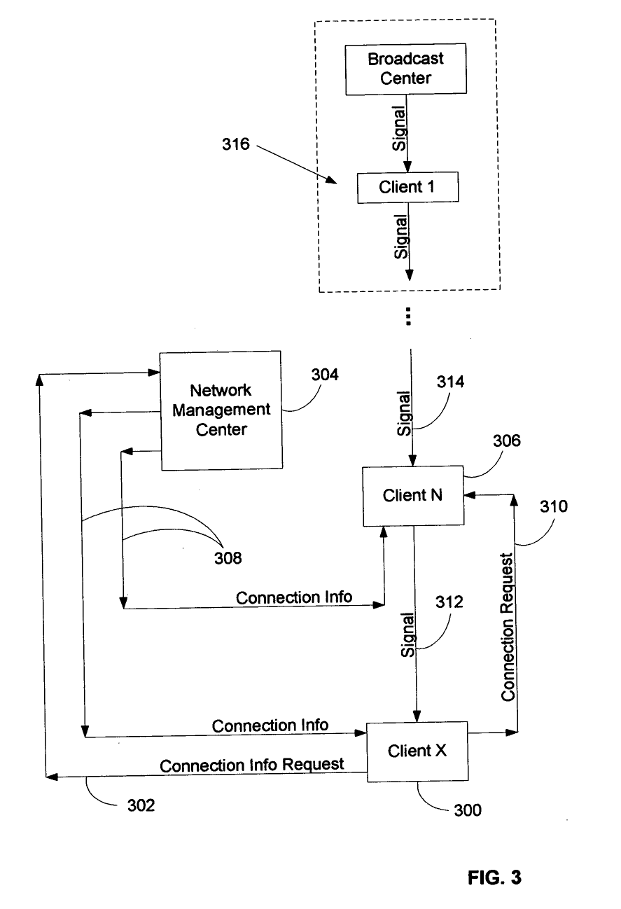

Referring to FIG. 3, to add new clients generally, such as a new client X 300, the new client X 300 sends a Connection Info Request 302 to the Network Management Center 304. Network Management Center 304 evaluates the broadcasting capacity of all active clients and chooses client N 306 as the source of the signal 312 for Client X 300, as will be explained below. The Network Management Center 304 then sends Connection Info 308 to both Clients X 300 and N 306. Client X 300 sends a Connection Request 310 to the source as defined in Connection Info 308, which in this case is the client N 306. Client N 306 then starts sending the signal 312, which is identical to the signal 314 it is receiving from its source 316, whatever that might be. The source 316 can have Broadcast Center sending the signal to a client, or even to an entire tree of clients, for example.

Regarding the Connection Info Request 302 of FIG. 3, when a client X 300 wants to connect and receive a signal 312, the first thing it must do is send a Connection Info Request 302 to the Network Management Center 304.

The Connection Info Request 302 can be implemented in a variety of ways. One preferred method is a standard HTTP call, submitting a form to the Network Management Center 304. The Network Management Center 304 has a public IP address, accessible via the standard DNS infrastructure.

A Connection Info Request form contains the following fields:
Client user name (optional)—used to authorize access to private streams
Client password (optional)—used to authorized access to private streams
Client IP
Client software version
Channel—specifies the unique public name of the wanted stream
Control Port—an IP port that the new Client is able to use to receive and transmit control data.

If the Connection Info Request is a request for access to a private stream, and the user name and password are missing, then the Network Management Center will issue a separate authentication request, preferably using SSL to secure the information exchange.

To decide which client N 306 will become the source of the signal 312 for Client X 300, the Network Management Center 304 constructs a virtual tree of Clients. There are many ways to implement such a tree, as will be described below. Regardless of the particular way the tree is implemented, it is preferable to be efficient.

When a new Client submits a Connection Info Request, the Network Management Center evaluates the most efficient way to expand the client tree structure. A preferred embodiment is set forth below of implementation-specific tree-expansion logic, as well as specific tree-expansion algorithms. Tree-expansion logic considers currently available Clients, their ability to retransmit a specific stream that the new Connection Info Request specified, and the impact such tree expansion will have on the Network Management Center, as well as on the global network.

Constructing an IP Proximity Tree requires consideration of each node's ability to handle outgoing streams, as defined below, and consideration of IP Proximity between the nodes. IP Proximity (IPP_{1,2}) shall be defined as a difference between two IP addresses IP₁ and IP₂, as calculated by the following formula:
IP₁=a.b.c.d
IP₂=w.x.y.z
IPP_{1,2}=|d−z|+2⁸×(|c−y|)+2¹⁶×(|b−x|)+2²⁴×(|a−w|)

The smaller the IPP between two Clients, the closer those two clients are to each other, as far as Internet infrastructure is concerned. The basic assumption is that Clients with similar IP addresses have fewer routers interposed between them. Therefore, it is more likely that they will be able to communicate more efficiently and more reliably.

Two network nodes on the same IP segment will have a smaller IPP than two nodes located on separate networks. By preferring interconnection between nodes located in the same (or close) subnets, redundant load on gateway routers is minimized, and efficient infrastructure utilization is ensured.

For example, as a direct outcome of IPP optimization, we will interconnect all clients located in the same household and listening to the same stream. Because of such local interconnection, only a single stream will enter through the gateway router. All clients in the household will be interconnected using a local tree, called an IPP Range, and all traffic will be over the local network. This will eliminate redundant transmission of identical streams over the entire Internet infrastructure.

If a second household, connected to the same Internet Service Provider (ISP) as the household in the example above, decides to listen to the same stream, because of IPP it will interconnect with a client in the first household. This, again, will eliminate redundant traffic over the ISP's gateways and the entire Internet infrastructure.

A single stream into an ISP will be sufficient for an unlimited number of interconnected clients located within the ISP's subnet. If two ISPs connect to the same source, then IPP will cause them to interconnect to form a single IPP range, such as IPP Range 1 in FIG. 4, and a single stream entering the above source will be enough for both of the ISP's.

Under this tree structure, Clients located very far from our Broadcasting Center will feed from each other, utilizing a single long distance link.

The resulting virtual Client tree, as shown in FIG. 4, in this example having three IPP Ranges (1, 2, and 3) promotes efficient communications and eliminates unnecessary long distance hops.

Outgoing Streaming Capacity of a node (client) in a network is the number of outgoing streams that a given node can handle. Not every node can handle the same number of outgoing streams. The capacity depends on operating system, hardware, network connection, available processing power, or system configuration.

The final outgoing streaming capacity is a combination of all the factors. It can be hard-coded into the device software, defined by the user during system configuration, periodically adjusted, or dynamically assessed during interconnection process.

Limiting the nodes to no (0) outgoing streams would cause all nodes to connect directly to the Broadcast Center. This would create a schema similar to the regular streaming solution where the server handles all bandwidth.

Limiting the nodes to a single (1) outgoing stream would cause all nodes to connect in a single long chain. This would solve the bandwidth issues. However, it would cause a very high channel latency, as the last node in the chain would receive the signal considerably after the first one receives it. Channel latency is the difference between the time the Broadcast Center broadcasts a signal and the time when a distal client actually receives it.

For example, if a single interconnection causes a delay of 0.1 seconds, and if the total number of nodes is 1,000 then the latency between the first and last nodes would be:

$$\frac{1000 \times 0.1 [ sec ]}{60 [ min ]} = 1.66 min$$

If the total number of nodes is 1,000,000 then the latency goes up to 27 hours. For this reason, it's important to maintain a tree structure with a modest number of levels.

A fixed number of two (2) outgoing streams per node is reasonable. It does not overload a node's processing capacity, and can provide a small enough tree even when the number of total recipient is very large.

For example, if X is the number of nodes, and every node is broadcasting to two others, then the number of layers in the tree (n) is:
n≈Log₂X−1

Thus, we need less than 30 layers to accommodate one billion (1,000,000,000) interconnected nodes. The latency between the first and the last node is:
30×0.1[sec]=3 sec

This is a small enough latency, which is similar to and acceptable for regular radio, TV or cable broadcasts.

When a network contains nodes that might not be able to handle two outgoing streams, it could be advantageous to introduce dynamic outgoing stream capacity assessment for every node, and possibly for every connection in some applications. Depending on the specific network topography, a node could handle a large number of outgoing streams to some nodes, but a very small number of outgoing streams to others.

Such diversity in outgoing stream capacity could be a result of different communications speeds and different bandwidth availability in different network segments. For example, a node could be able to stream to a large number of local recipients over a high speed Local Area Network. The same node would only be able to stream to a significantly smaller number of recipients that are in another building, outside the LAN.

One possible way to address dynamic outgoing capacity is to measure the actual node performance and raise or lower it as necessary. It is important to measure both processing and networking performance of the node.

Nodes whose hardware or operating system does not provide for such measurement will have to utilize a fixed number of maximum outgoing streams.

As described above, the preferred embodiment is two (2) streams per node.

Numerous different implementations of logical tree structures have been successfully deployed over the years. The exact implementation is not material to the core invention, as long as the logical tree structure is efficient and effective.

Table 1 describes the preferred embodiment for a nodes table structure:

TABLE 1

| Field | | |
|---|---|---|
| name | Content | Description |
| ID | A very large | Network Management Center assigns |
| | integer | a new unique identifier to a node |
| | | every time a node connects. This is |
| | | how other nodes refer to this node. |
| IP | Four sub-fields, | Public IP address. Because of |
| | a single bytes | possible firewalls and Network |
| | each | Address Translation (NAT) devices, it |
| | | is different form the node's actual IP |
| | | address. This is what the external |
| | | world will use to communicate with |
| | | this node. |
| IP | Four sub-fields, | Internal IP address. This is the actual |
| Internal | a single bytes | IP address assigned to the device. |
| | each | Because of NAT devices, this can be |
| | | different from the IP address that the |
| | | external world detects. It is meaningful |
| | | only in the context of the local |
| | | network. Internal IP address is useful |
| | | when interconnecting devices located |
| | | in same IP subnet. |
| Max | A small integer | Maximum number of outgoing |
| Streams | | connections this node can handle. |
| | | This can be a dynamic number or a |
| | | static one, as described in the chapter |
| | | about outgoing stream capacity. |
| Streams | A small integer | Number of active outgoing |
| | | connections. This is the number of |
| | | streams that the node is actual |
| | | streaming. Every time a new node is |
| | | connected, we increment this number. |
| | | A node is capable to receive |
| | | additional outgoing connections as |
| | | long as this value is less than Max |
| | | Streams. |
| Source | A very large | ID of assigned source. |
| ID | integer | |

It is important to index the nodes table based on both ascending and descending order of IP. It will be instrumental when expanding the tree in an efficient way.

The first record, ID=0, will be populated with our Broadcast Center information.

The following Tree Expansion method describes how the Network Management Center decides what node is going to serve as source for a new node requesting to connect:
a) Populate all fields in the new node's database record, except Source ID.
b) Query the nodes table, sorted by ascending IP, for the first node with Streams<Max Streams and IP larger than the new node's IP so as to return the first node that can handle additional outgoing streams, with an IP address larger than the new node's IP.
c) Query the nodes table, sorted by descending IP, for the first node with Streams<Max Streams and IP smaller than the new node's IP so as to return the first node that can handle additional outgoing streams, with an IP address smaller than the new node's IP.
d) If both queries returned results, then calculate the IPP between them and the new node. The node with the smaller IPP is the new node's source.
e) If only one of the queries returns a result, then this is the new node's source.
f) If no queries return results, then the new node is the first one attempting to connect to the specific signal. The Broadcast Center (ID=0) will be assigned as source.

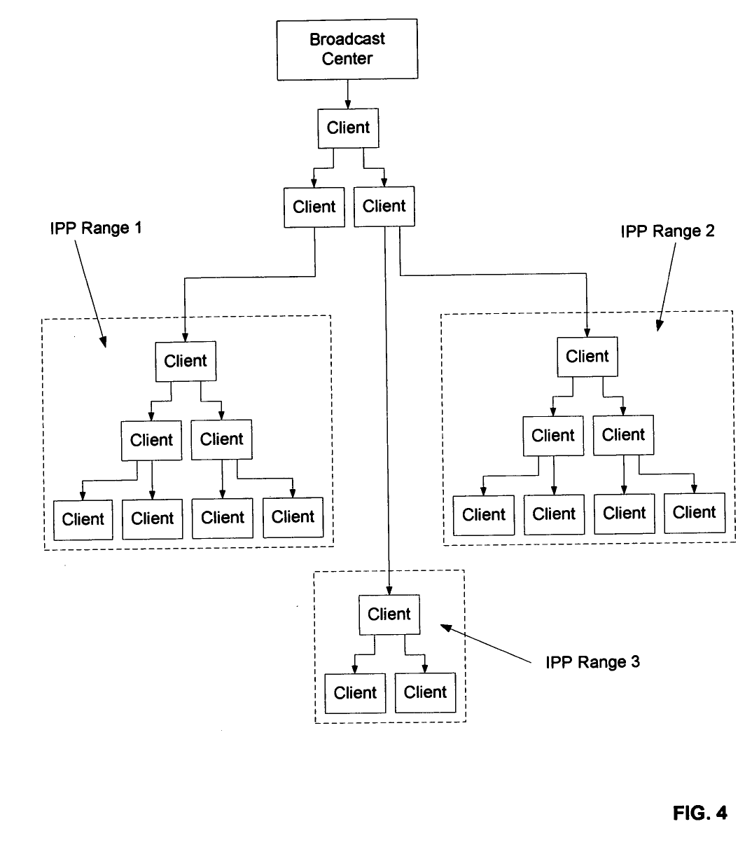

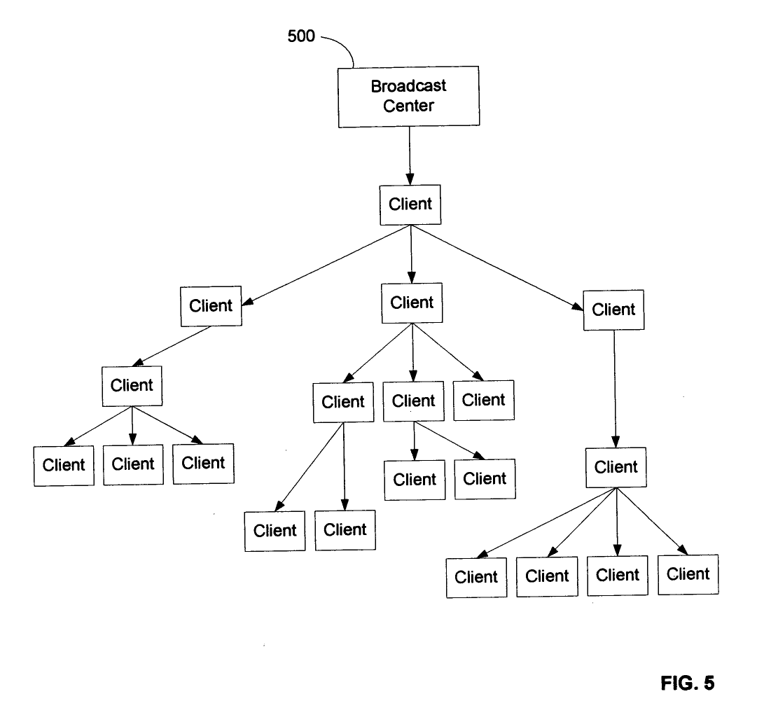

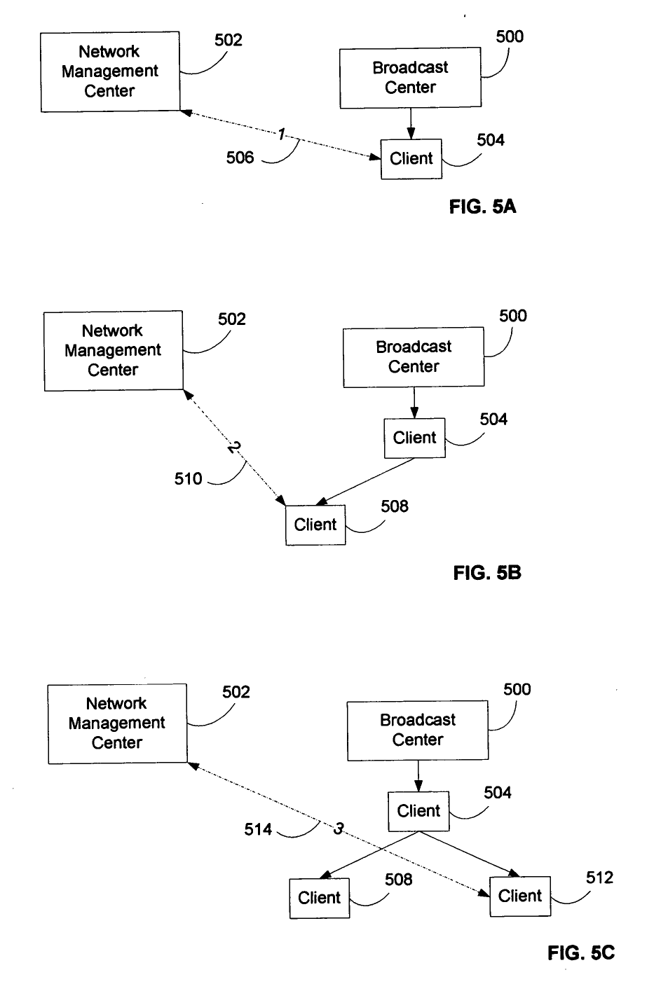

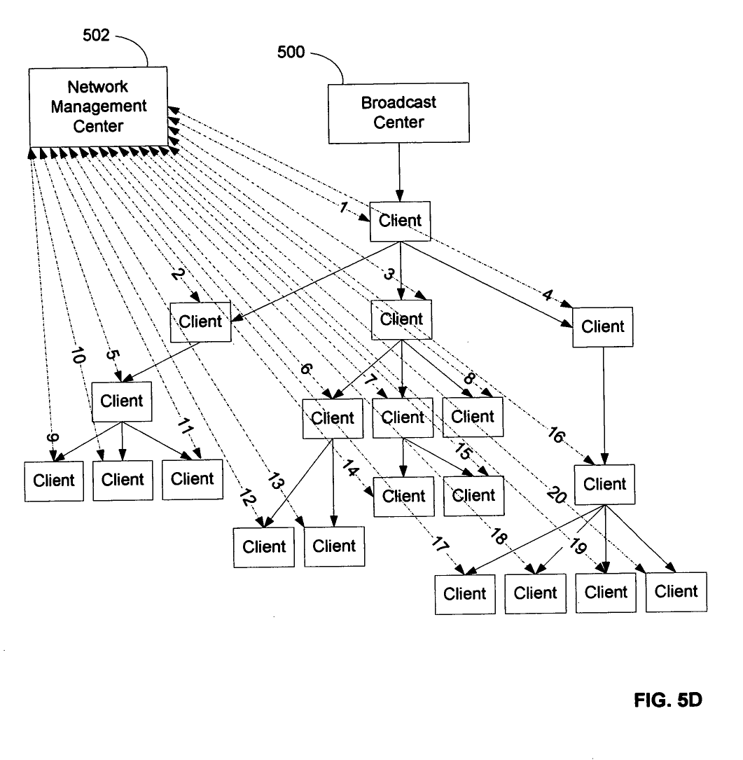

A Dynamic Tree is a subset of an IP Proximity Tree, where the IPP between all IP addresses is identical, or is assumed to be identical. In this structure, as shown in FIG. 5, every Client may retransmit to a different number of new Clients, based on its outgoing stream capacity.

This tree may have many layers, resulting in longer channel latency. However, there will be less timeouts because clients with borderline capacity are not forced to transmit more streams than they actually can. This tree structure will improve overall network performance by adjusting the structure to actual client capabilities.

The following method describes how the Network Management Center decides what node is going to serve as the source of the signal for a new node requesting to connect:
a) Populate all fields in the new node's database record, except Source ID
b) Query the nodes table, sorted by descending ID, for the first node with Streams<Max Streams so as to return a node that can handle additional outgoing streams.
c) If the query returned a result, then this is the new node's source.
d) If the query did not return a result, then the new node is the first one attempting to connect to the specific signal. The Broadcast Center (ID=0) will be assigned as source.

FIG. 5 shows a Broadcast Center (BC) 500 sending a signal to a plurality of clients connected to the BC, the plurality of clients being connected in a tree structure wherein each client can retransmit to a different number of new clients, the number based on the outgoing stream capacity of the transmitting client, as explained above.

FIGS. 5A-5C illustrate how the tree of FIG. 5 is built by adding one client at a time.

FIG. 5A is a schematic diagram of a first client 504 being added to a CP2P network of the invention by communicating 506 with a Network Management Center 502 so the first client can receive a signal from the Broadcast Center 500.

FIG. 5B is a schematic diagram of a second client 508 being added to a CP2P network of the invention by communicating 510 with the Network Management Center 502 after the second client 508 has communicated with the Network Management Center 502 so that the second client 508 can receive the signal from the first client 504.

FIG. 5C is a schematic diagram of a third client 512 being added to a CP2P network of the invention by communicating 514 with the Network Management Center 502 after the first and second clients 504,508 have communicated with the Network Management Center so that the third client 512 can receive the signal from the first client 504.

FIG. 5D is a schematic diagram of a CP2P network of the invention having a plurality of clients connected in a tree structure and receiving a signal thereby from a Broadcast Center 500, each client being added sequentially by briefly communicating 1-20 with a Network Management Center 502.

A Binary Tree is a subset of Dynamic Tree, where all nodes (clients) have an identical outgoing stream capacity of two (2). It is a relatively simple solution to implement, and is very popular with programmers whenever a logical data tree structure is required.

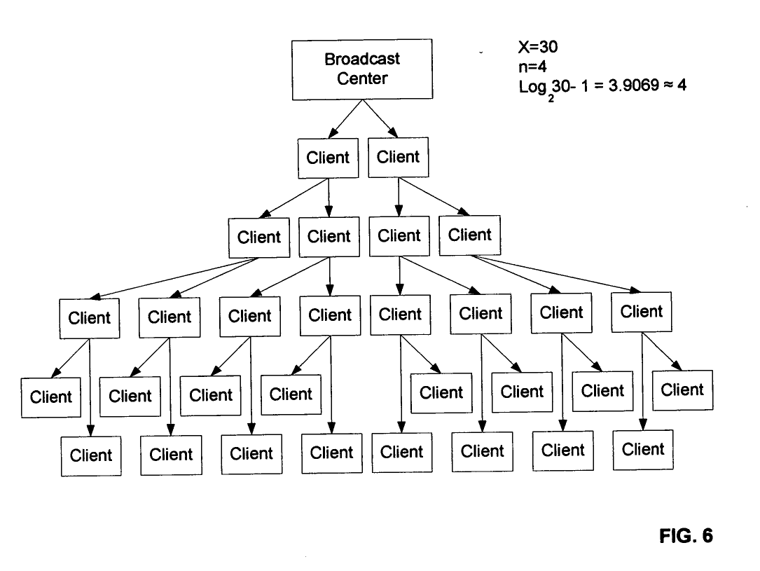

In a binary tree, as shown in FIG. 6, when X is the number of Clients and n is the number of layers, then:
n≈Log₂X−1

Using a binary tree, an extremely large number of nodes can be organized in a relatively low number of layers, thus achieving reasonably low channel latency.

As shown in a previous example, one would need less than 30 layers to accommodate one billion (1,000,000,000) interconnected nodes and achieve a channel latency of no more than 3 seconds. This is a preferred embodiment.

The following Tree Expansion method describes how the Network Management Center decides what node is going to serve as source for a new node requesting to connect to the binary tree.
a) Populate all fields in the new node's database record, except Source ID.
b) Set Max Streams=2.
c) Query the nodes table, sorted by descending ID, for the first node with Streams<Max Streams so as to return the first node that can handle additional outgoing streams.
d) If the query returned a result, then this is the new node's source.
e) If the query did not return a result, then the new node is the first one attempting to connect to the specific signal. The Broadcast Center (ID=0) will be assigned as source.

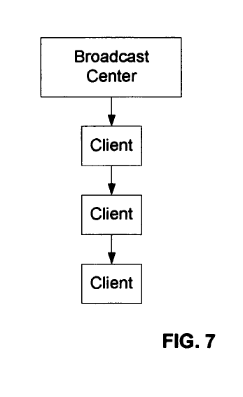

A Serial Link, as shown in FIG. 7, is a subset of the binary tree of FIG. 6, where every node is limited to a single outgoing stream. This structure creates a chain of Clients, as long as the total number of Clients listening to a specific stream. In a Serial Link, X=n. A Serial Link is not the natural choice for high capacity clients, such as a personal computer, capable of handling numerous outgoing streams. As previously shown, it also introduces high channel latency. However, Serial Link can be advantageous when interconnecting less capable nodes, such as Internet enabled cellular phones, personal digital assistants (e.g., Palm or Pocket PC handhelds), or car devices in vehicles with Internet access. Serial Link could serve very well as a regional tree structure between devices with close IPP. For example, all handheld devices could be linked together in a single household. It could be effective to link together all cellular telephones connected to the same cellular tower.

The following Tree Expansion method describes how the Network Management Center decides what node is going to serve as source for a new node requesting to connect to a Serial Link:
a) Populate all fields in the new node's database record, except Source ID.
b) Set Max Streams=1.
c) Query the nodes table, for a node with Streams<Max Streams so as to return the last node in the link.
d) If the query returned a result, then this is the new node's source.
e) If the query did not return a result, then the new node is the first one attempting to connect to the specific signal. The Broadcast Center (ID=0) will be assigned as source.

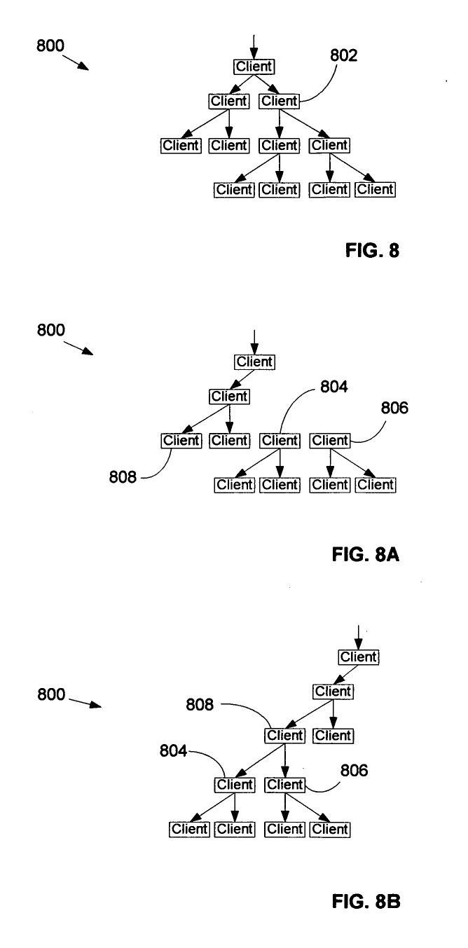

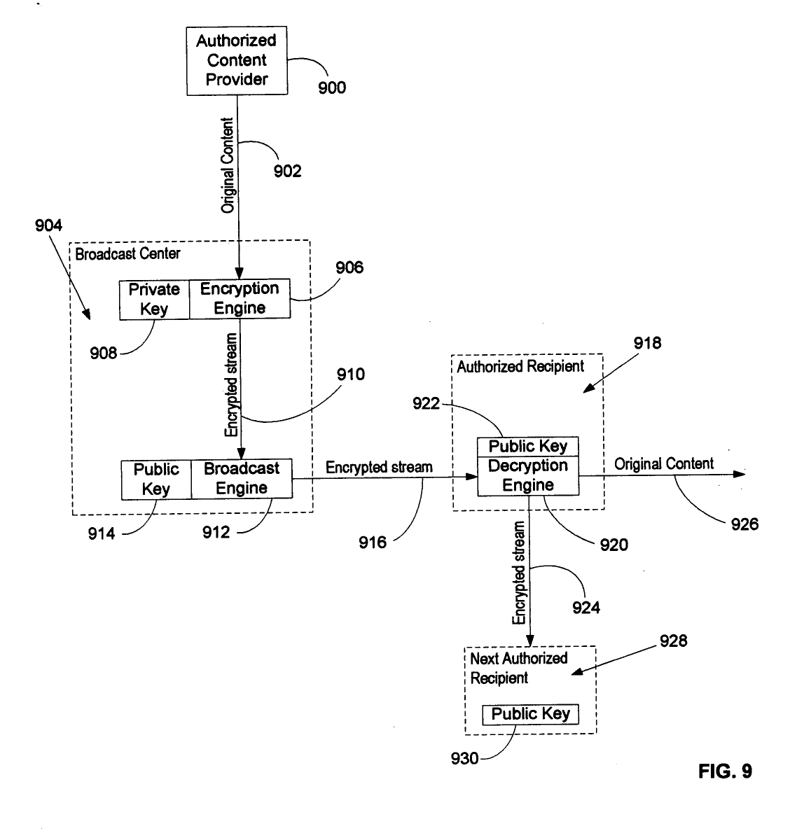

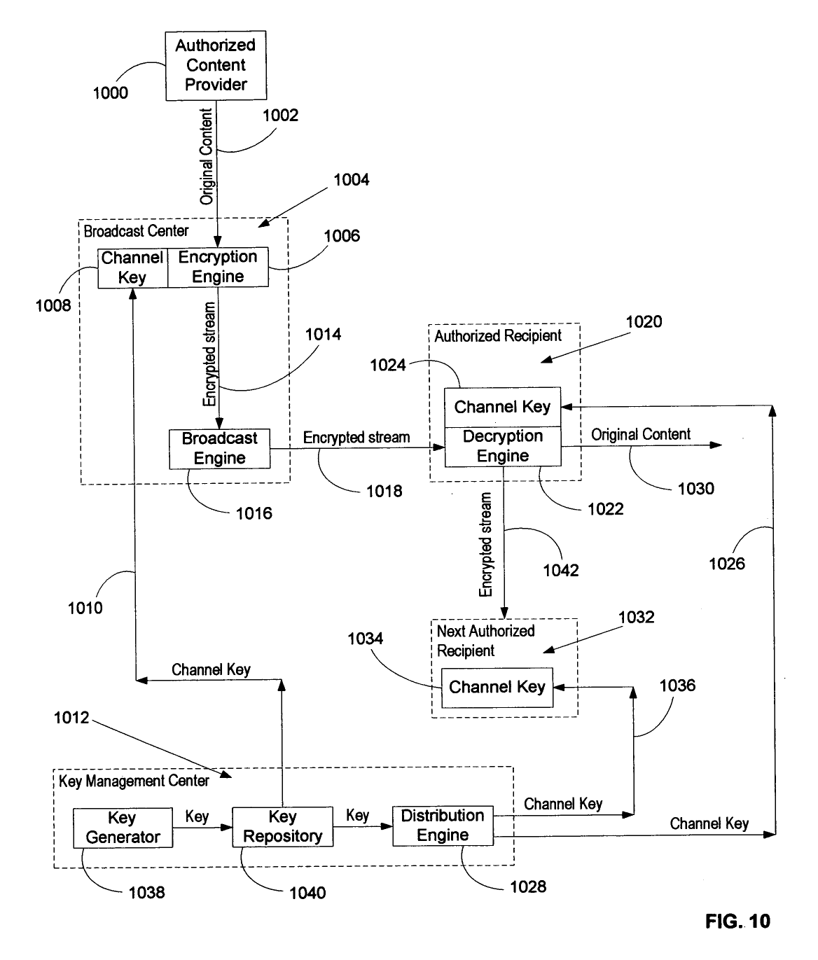

With reference to FIG. 8, in an interconnected network 800 such as the Controlled Peer-to-Peer network of the invention, it is important to know when a client disconnects, and to handle this event in a particular way. A disconnected client affects all of the clients below it in the logical tree structure, since a disconnected client does not receive a signal, and therefore cannot provide a signal. Thus, when a client 802 drops out of the network 800, the clients 804 and 806 that received a signal from the client 802 now cannot provide a signal to all the clients below them in the network 800.

To maintain positive connectivity awareness, the invention enables a disconnected client to send a “heartbeat signal” to all clients that previously received the signal originally received by the disconnected client.

To send a heartbeat signal, a disconnected client transmits an empty command (NOP) over the control channel, meaning nothing other than the fact that a channel exists. The frequency of such NOP commands determines the responsiveness of the network to a dropping out client. A very slow frequency NOP command will cause clients to be unaware of the fact that their signal is gone for a long time. A very high frequency will create a responsive network, but it will also add overhead to the communications lines. Our preferred embodiment is a period of one NOP command every 10 seconds.

A NOP is only required when there is no signal in the main channel of a disconnected client. If nothing is received over the main channel, and the NOP does not come in within the preset time, e.g., 10 seconds, then a disconnected client needs to reconnect to a new signal source. During the reconnection process, as described below, the disconnected client will continue sending the heartbeat (NOP) to all of its dependents to maintain the tree structure below itself.

When a client discovers, via the process of missing the heartbeat signal, that the source for its stream is no longer present, it needs to reestablish a connection to a new stream source.

To prevent all clients in the same tree from reacting to the fact that the signal is no longer present, every client will transmit a NOP after only half of the preset time interval passes. This procedure ensures that only the clients previously connected directly to the client that dropped out initiate the reconnection procedure.

The following is a description of the reconnection procedure:
a) The reconnecting client continues transmitting NOP to all of its assigned recipients. This ensures that none of the nodes below the reconnecting client in the tree need to be reconnected.
b) The reconnecting client initiates a connection procedure, using the tree expansion algorithm, as previously described.
c) After the client begins receiving the stream, all the nodes below that client in the tree receive the stream as well.

This process is illustrated in FIG. 8B, wherein the disconnected and reconnecting clients 804, 806 reconnect to the client 808 in the tree 800.

Occasionally, the reconnection process using the standard tree expansion procedure may add extra layers to a tree. It may sometimes be advantageous to rebuild the entire tree and achieve minimum channel latency.

Our preferred embodiment for the process of rebuilding a tree is to start a new tree, and add all new connections to the new tree only. Eventually, when all nodes of the old tree happen to disconnect or change channels, the old tree will disappear and only the new tree will remain.

It is also possible to rebuild only portions of a tree. This can be especially feasible when using the IPP tree method.

Connection Info, as seen in FIG. 2A where it is sent as the signal 206 from the Network Management Center 204 to both an existing client 216 and a new client 200, is a transmission of all the information necessary to establish a secure and authenticated link between the new client 200 and the existing one 216.

We can implement Connection Info 206 using a multitude of techniques. One preferred option for implementing Connection Info 206 is by using a standard HTTP protocol to send a standard form to the requesting Client.

Connection info contains the following fields:
Source IP address—this is the IP address of a Client that Network Management Center assigned as source. This is how the requesting Client will locate the assigned transmission source.
Source Control Port—this is the IP port that the assigned source uses to send and receive control information.
Listener Control Port—this is the IP port that the listener uses to send and receive control information.
Listener's IP address—IP address of the Client that requested a connection to a data stream. This is the IP address that the assigned sender will transmit to.
Connection string—this string is a single use random string, used to verify that source and destination match up. The source uses the Connection string to verify that the Network Management Center (NMC) authorized the requesting Client to connect. To verify, the source compares the Connection string as received from NMC to that received from requesting Client. Matching connection strings mean that NMC authorized this connection. The motivation for it being a single use string is to eliminate the possibility of past interconnection credentials (Connection string) being re-used. It is important to ensure the controlled nature of the network of the invention.
Connection Time Alive—maximum number of minutes this specific connection will be valid after receipt of Connection Info. If a Client does not establish a connection within Connection Time Alive minutes, this connection expires. The Connection Time Alive may vary with application. For audio broadcast over the Internet, the preferred embodiment for Connection Time Alive is 2 minutes. The motivation for this field is to ensure that interrupted connection attempts do not clog the system for too long. If a connection is not established within Connection Time Alive, then the source node becomes available for a new connection.

After receiving Connection Info 206, a new Client (receiver) 200 will attempt to connect to the assigned Source 216. The receiver 200 will send a Connection Request 210 to the Source 216, containing the following fields:
Channel Name—a unique name that Network Management Center assigns to a signal.
Listener's IP address—receiver's IP address.
Connection string—serves as a one-time password to signify a legitimate connection. See description and use in “Connection Info” above.

A Connection Request 210 can be implemented using a multitude of techniques. One preferred implementation is by submitting a form to the assigned transmitter, using HTTP to the sender's Control Port, as defined in the Connection Info 206.

The assigned Source 216 verifies validity of the new Client (receiver) 200 by comparing Listener's IP address and Connection String from Connection Request 210 it received from the new Client 200 to the appropriate values in the Connection Info 206 it received from the Network Management Center 204. If everything matches, and the time since the reception of Connection Info 206 is less than Connection Time Alive as specified in Connection Info 206, then the streaming will begin.

After the recipient establishes a standard HTTP link with the sender, the sender will start streaming whatever it receives from its source, whatever the source and the content might be.

The invention prevents unauthorized modifications to content as well as preventing introduction of new content created by unauthorized sources. This is accomplished by incorporating encryption techniques into the broadcast stream.

The invention utilizes standard private-public key encryption technology. The basic premise of private-public key encryption is that the two keys act as a pair. If one serves to encrypt the content, then the other one is required to decrypt it, and vice versa. This enables one party to keep the encryption key in total secrecy, without ever sharing it with anyone, while the public can verify the authenticity of the sender by the mere fact that it can decrypt the content using the public key.

With reference to FIG. 9, an Authorized Content Provider 900 creates the content and streams it 902 to the Broadcast Center 904. In the Broadcast Center 904, the Encryption Engine 906 uses the Private Key 908 to create the Encrypted Stream 910 and then forwards it to the Broadcast Engine 912. The Broadcast Engine 912 forwards the Encrypted Stream 916 to an Authorized Recipient 918, along with the Public Key 914 if so requested by the recipient.

The Authorized Recipient 918 uses a Decryption Engine 920 and the Public Key 922 to recreate the original content 926 for its internal use.

If Authorized Recipient 918 also serves as a source for the Next Authorized Recipient 928, then it can retransmit the original Encrypted Stream 916 as the stream 924. The Next Authorized Recipient 928 uses an identical process to decrypt the stream 924 by means of the Public Key 930.

In another embodiment called a Symmetric Encryption Based Solution, Authorize Content Provider 1000 creates the content 1002 and streams it to the Broadcast Center 1004. In the Broadcast Center 1004, the Encryption Engine 1006 uses the Channel Key 1008, which was received 1010 from the Key Management Center 1012, to create the Encrypted Stream 1014 and then forwards it to the Broadcast Engine 1016. The Broadcast Engine 1016 forwards the Encrypted Stream 1018 to an Authorized Recipient 1020.

The Authorized Recipient 1020 uses a Decryption Engine 1022 and the Channel Key 1024, which was received 1026 from the Distribution Engine 1028 in the Key Management Center 1012, to recreate the original content 1030 for its internal use.

If Authorized Recipient 1020 also serves as a source for the Next Authorized Recipient 1032, then it can retransmit the original encrypted stream 1042. The Next Authorized Recipient 1032 uses an identical process to decrypt the stream by means of Channel Key 1034, which was received 1036 from the Key Management Center 1012.

Every time we create a new channel, the Key Generator 1038 generates a secret key for that individual channel. All keys are stored in the Key Repository 1040 for later retrieval and distribution by the Distribution Engine 1028.

Clients can only connect to other clients after receiving a time and content sensitive Connection String from the Network Management Center. It is important to include time and content references in the Connection String. This will ensure that the connection is only valid within a limited time; connection authorizations should not last indefinitely.

A stale connection authorization may refer to a source that no longer exists or is no longer able to add additional listeners. Content authorization is very important to ensure that the source is still receiving the intended stream. If the source changes to a different stream, then the content will not match, and the connection is no longer valid. It is important for the Connection String to be a one-time use only. This ensures that same connection is not re-used.

Without proper authorization, a client will not be able to connect to another client's outgoing stream.

The Network Management Center will generate and distribute one-time Connection Strings to authorized pairs of peering clients. In order to create a Peer-to-Peer connection, both the transmitting and the receiving clients will need to posses identical one-time Connection Strings.

This process will create a fully managed and controlled peer-to-peer network. The Network Management Center will be responsible for proper peering of clients based on content, performance, compatibility or other technical, logical, geographical, or business criteria.

For example, it would defeat logic to interconnect clients interested in different content, or with incompatible hardware or software. Interconnecting clients within a network segment demands a lesser toll from the network gateway devices.

There could be many logical reasons to limit interconnection between clients. For example, interconnection between all students in a school creates an ad-hoc public announcement (PA) system.

Another example would be interconnection of all nodes within a firm, thus creating an internal PA system. Such interconnection control would provide a secure environment for internal announcements to all nodes, regardless of their current physical location. A president of a firm could address all his employees, even those that happen to be home or on the road.

In a preferred embodiment, every stream includes a Control Channel that the Broadcast Center uses to communicate stream-related information to all or some channel recipients. The information can be synchronous or asynchronous, as defined further herein.

Stream-related information includes information about the stream, such as:
Name of the song currently being transmitted
URL of a website that can offer more information about the current content
URL of a website that is offering the song for sale
New encryption keys, as part of key distribution process described further below.
Control commands for the Control Command Interpreter (as described further below) that change the appearance or functionality of a client.
Various messages for the user
Advertisements
Announcements from Broadcasting Center
Any other content, information or commands that are not an integral part of the audio stream.

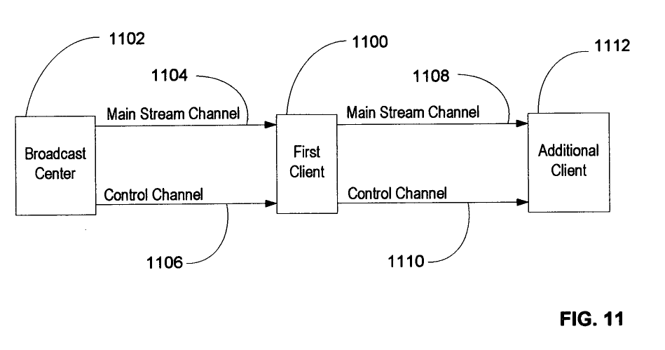

FIG. 11 shows how a control channel 1106 accompanies a main stream channel 1104. When the first Client 1100 connects to the Broadcast Center 1102, in addition to establishing a Main Stream Channel 1104, it also establishes a Control Channel 1106. When an additional Client 1112 connects to a source, which in this case is the first Client 1100, to establish a Main Stream Channel 1108, it also establishes a Control Channel 1110. Every connection between two peering Clients includes two channels, a Main Stream Channel and a Control Channel.

Clients will interpret, and act upon, asynchronous control data as soon as they receive it. Such data can include new encryption keys, or be part of key distribution process, various messages to the user, elective advertisements, unsolicited proposals, or any other type of announcements from the Broadcasting Center. Such announcements could originate at the Broadcast Center, or be transmitted by the Broadcast Center as a service to other system components.

Clients will interpret, and act upon, synchronous control data in context with the synchronization data embedded in the main stream that they receive.

The Broadcast Center may embed unique synchronization information in the main stream that it transmits, or such synchronization information may be a natural component of the signal, enabling the Clients to match Synchronous Control Channel Content with the actual stream that they receive.

Such synchronization allows the Client to perform various content sensitive tasks. This technique can be used to display advertisements that relate directly to the content while the Client is experiencing it, to convey real-time surveys about the content, or to provide other services to enhance user experience. This will improve advertisement effectiveness and expand service options to both Clients and content creators.

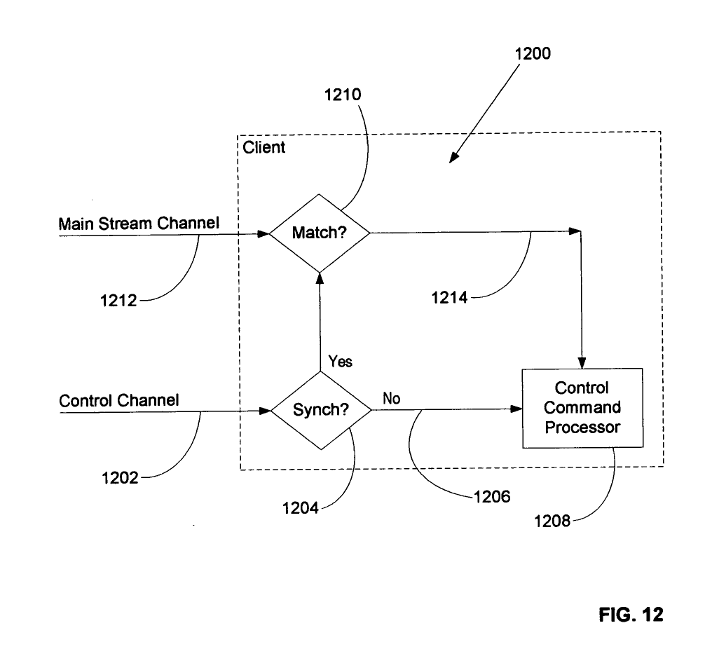

FIG. 12 describes the process of handling Control Channel data by the Client. When a Client 1200 receives a Control Channel Message 1202, it first checks whether this is a synchronous 1204 command. If the command is asynchronous, then it is passed 1206 to the Control Command Processor 1208 for immediate processing. If the command is synchronous, then it will wait 1210 for a matching synchronization event in the Main Stream Channel 1212. When such a match is found, the Control Command is passed 1214 to the Control Command Processor 1208 for immediate processing.

Clients in a traditional peer-to-peer network are vulnerable because they depend on a peer to provide proper content and expose their own content, or data, for download by connected peers.

As available processing power increases, and Public/Private Key Encryption processing becomes more effective, the entire stream can be encrypted. If a client is able to obtain a proper data stream after decrypting the cipher with an appropriate Public Key, then that is evidence that a holder of a matching Private Key created the stream.

Further, clients of the invention do initiate a connection independently, and therefore cannot access any other clients. The only way for client of the invention to listen to a stream is by first obtaining individual link security credentials and source address from the Network Management Center. Clients will not broadcast their address and will not provide any connectivity related information, except through a secure connection to the Network Management Center.

Another embodiment of the invention provides Public/Private Key Based Stream Authentication. Clients of the invention cannot create and therefore do not provide any content, other than relaying what they receive from the Broadcast Center. A client can confirm the original source of the content to be the Broadcast Center by verifying the electronic signature during the connection process. A client can verify validity of the stream by the mere fact that it can be decrypted using the Public Key.

Another embodiment of the invention provides Symmetric Encryption Based Stream Authentication. A client can confirm the original source of the content to be the Broadcast Center by verifying the electronic signature during the connection process. A client will use the Synchronized Control Channel to verify that the content remained in tact while in transit, as explained below.

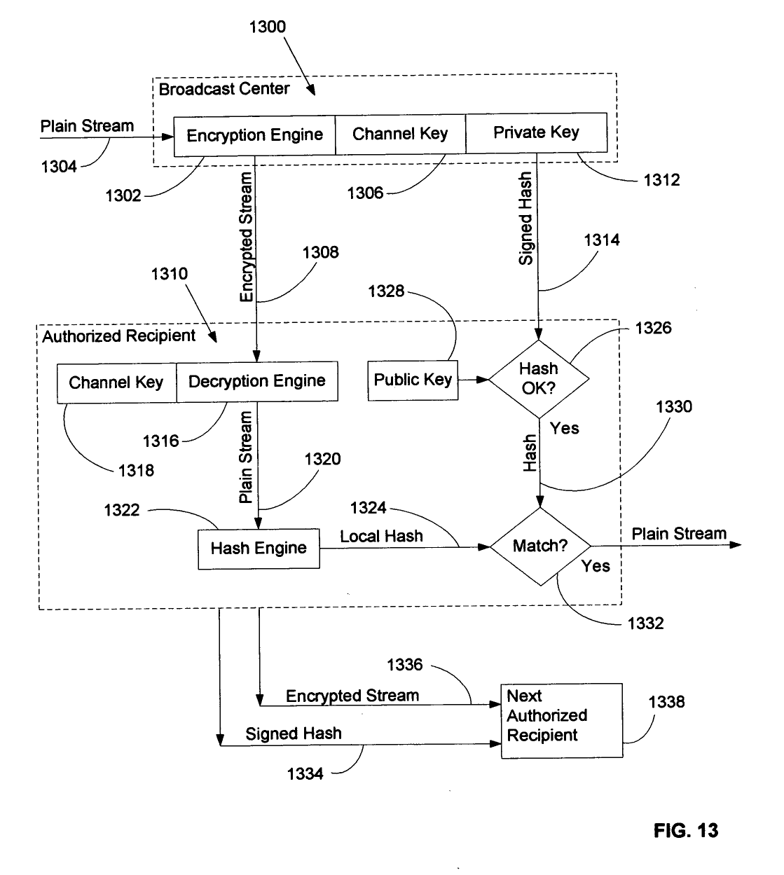

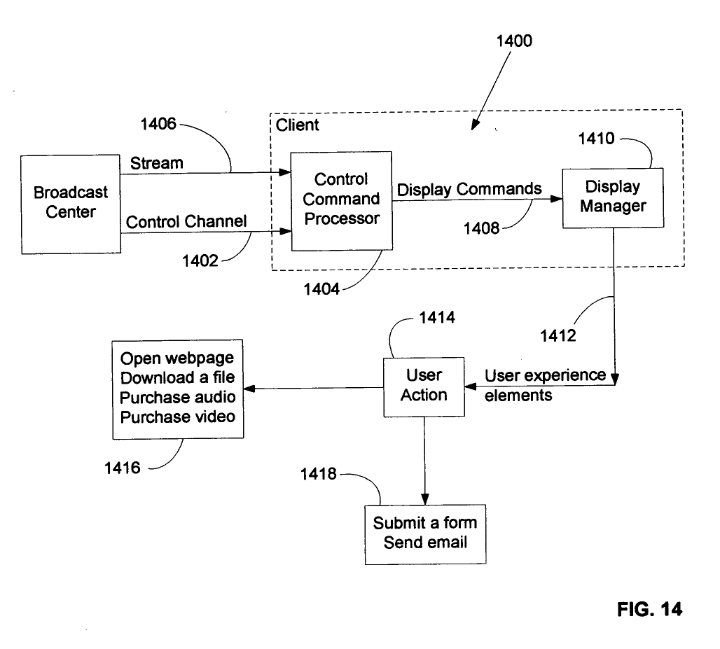

With reference to FIG. 13, the stream authentication process is described. Broadcast Center 1300 uses Encryption Engine 1302 to encrypt the Plain Stream 1304 by means of Channel Key 1306. The Broadcast Center 1300 then sends the Encrypted Stream 1308 to the Authorized recipient 1310 via the main channel.

The Encryption Engine 1302 also creates a message Hash (see definition below), signs it using the Private Key 1312, and sends 1314 it to the Authorized Recipient 1310 via the Control Channel.

At the Authorized Recipient 1310, the Decryption Engine 1316 decrypts the stream using the Channel Key 1318 to obtain the Plain Stream 1320. The Hash Engine 1322 creates a Local Hash 1324.

The Signed Message Hash 1314 is certified 1326 by means of the Public Key 1328 to obtain a certified Hash 1330. The Authorized Client 1310 then compares 1332 between the certified Hash 1330 and the Local Hash 1324, and if there is a match then the message content is valid.

The next Authorized Client receives the Signed Message Hash 1334 over the Control Channel and the Encrypted Stream 1336 via the main channel.

The SHA (Secure Hash Algorithm) family is a set of cryptographic hash functions. SHA-1 is the most commonly used function in the family. It is implemented in a large variety of popular applications and protocols, including TLS, SSL, PGP, SSH, S/MIME, and IPSec. The SHA algorithms were designed by the National Security Agency (NSA), and published as a US government standard FIPS PUB 180-1.

SHA-1 produces a 160-bit (20-byte) output, commonly called message digest. For example, the message “The quick brown fox jumps over the lazy dog” will produce a message digest “2fd4e1c67a2d28fced849ee1bb76e7391b93eb12”.

The Control Channel is used to create a Synchronized Reverse Feed that will enhance user experience and enable gathering of user feedback with a direct link to content. The Clients of the invention can click on buttons or other “user experience elements” enabling users to capture client preferences and opinions. Clients of the invention can rank streams, in real time, make purchases based on current stream, or view a website relevant to current content.

The following are some possible implementations of this technology.
Real-time music feedback: while streaming a song, the invention displays a survey allowing listeners to express their opinion about the song.
Real-time broadcast feedback: while broadcasting a political speech, the invention displays buttons that enable listeners to vote in agreement or disagreement, or express their opinion in their own words.
Impulse purchase: while a client is receiving an audio or video stream, the invention enables the user to purchase relevant products.
Online music or video sales: while a client is streaming a song, a listener is able to click a link or a button and purchase an online version either directly from us or another site.

With reference to FIG. 14, Client 1400 receives various control commands via the Control Channel 1402. Control Command Processor 1404, described below, analyzes the commands. If a command is asynchronous, then it is immediately transferred 1408 to the Display Manager 1410, described below. If the command is asynchronous, then the Control Command Processor 1404 will wait for the synchronizing event in the main stream 1406, and only then transfer 1408 the command to the Display Manager 1410.

Display Manager 1410 interprets the commands and activates appropriate user experience elements 1412, such as display a message, present a form, enable buttons, activate various options, etc. The user can take action 1414 upon the displayed user experience elements. Those actions can be of a localized nature, 1416 such as display a webpage, download a file, or purchase an audio or video. Alternatively, those actions can be of bi-directional nature 1418, such as submit a form, or send an email message.

The Control Command Processor 1404 of FIG. 14 interprets all communications received via the Control Channel. Every command consists of a start byte, command header, optional command content, and an end byte.

TABLE 2

| Component | Value | Description |
|---|---|---|
| Start | 0x00 | Every control command starts with |
| Byte | | this byte. |
| Recipient | From | A value of 0x00 represents a |
| ID | 0x00000000 | command that is for all recipients of |
| | to | this control channel. Any other value |
| | 0xFFFFFFFF | is for the node whose ID is equal to |
| | | this number. |
| | | When a node receives a command |
| | | with its own ID, it should process the |
| | | command and there is no need to |
| | | transfer it to the next node. |
| | | When a node receives a command |
| | | with any other ID, including 0x00, it |
| | | should process the command and |
| | | retransmit it as is to all of its |
| | | recipients. |
| Command | 0x01 . . . | Single byte representing an |
| header | 0xFF | individual command. |
| Command | Anything | Command content is different for |
| content | | each command. It could contain the |
| | | ID of a specific node, or an |
| | | instruction to lower the audio |
| | | volume, a message to the listener, |
| | | or anything else that we define in |
| | | the future. This field can even |
| | | contain other, nested, commands. |
| End | 0xFF | Every command ends with this byte. |
| Byte | | |

The specific commands that the Control Command Processor will support will change as the demand for additional commands grows. Initially, the command set may include only the basics such as described in the table below.

TABLE 3

| | Header | | |
|---|---|---|---|
| Command | Value | Command Content | Description |
| Change | 0x01 | 4 bytes representing | Causes the client to |
| Channel | | Channel ID in Hex | change the channel it is |
| | | | receiving. If the client is |
| | | | currently transmitting to |
| | | | others, then NMC will |
| | | | redirect the others to a |
| | | | new source. |
| Display | 0x02 | Delimiter byte, plus a | Causes the client to |
| Message | | text message in | display a message to |
| | | standard ASCII, | the user. |
| | | ending with same | |
| | | delimiter. | |
| Display | 0x03 | Delimiter byte, plus a | Causes a client to |
| URL | | full URL encoded in | display the given URL. |
| | | standard ASCII, | |
| | | ending with same | |
| | | delimiter byte. | |

Sample commands:
00 00000000 01 00000002 FF—change all clients to channel ID=2
00 0000000B 01 00000011 FF—change client ID=11 to channel ID=17
00 00000000 02 00HELLO00 FF—all clients should display HELLO
00 00000003 03 00http://www.radiobond.com00 FF—client number 3 should display a link to http://www.radiobond.com

Note that all text messages in the above sample code appear as text for clarity. The actual command should contain the ASCII representation of every character, in HEX, rather the actual character.

The Display Manager 1410 of FIG. 14 is a software component that interprets all display related commands. For example, when a client is required to display a message “Hello”, the Display Manager 1410 handles the actual task of displaying. The main reason for such a separation is to make it easier to port the implementation to different platforms.

All Command Processors interpret all commands in same way. This ensures that all clients, regardless of the platform they run on, will behave consistently. However, a cellular phone, a PC, or a Mac will each display a text message differently. A cellular phone or a PDA may display it as a scrolling text on the bottom or top of the screen, a Mac may display it on the top of the window where the menu is, and a PC may display it in a separate pop-up window, close to the system tray.

Other modifications and implementations will occur to those skilled in the art without departing from the spirit and the scope of the invention as claimed. Accordingly, the above description is not intended to limit the invention except as indicated in the following claims.

What is claimed is:

1. An apparatus for broadcasting a signal to a plurality of clients, the apparatus comprising:
a network management center configured to receive connection information requests from the plurality of clients, and to provide connection information to at least one of the plurality of clients; and
a broadcast center, cooperative with the network management center, configured to receive the connection information, and to provide the signal.

2. The apparatus of claim 1, the broadcast center also being configured to receive a connection request, and being configured to provide the signal only after receiving the connection request, and then using the connection request with the connection information to allow the signal to be provided.

3. The apparatus of claim 2, wherein the connection information request and the connection request originate from a first client.

4. The apparatus of claim 1, wherein the connection information request originates from a first client, which first client then receives connection information.

5. The apparatus of claim 1, wherein a first client has been connected to the broadcast center and then receives a signal from the broadcast center, and
wherein a second connection information request and a second connection request originate from a second client, the second client receiving the signal from the first client only after the first client receives the second connection request, the first client then using the second connection request with connection information provided by the network management center to allow the signal to be provided to the second client.

6. The apparatus of claim 5, wherein the second client has been connected to the first client, and then receives a signal from the first client, and
wherein a third connection information request and a third connection request originate from a third client, the third client receiving the signal from the second client only after the second client receives the third connection request, the second client then using the third connection request with connection information provided by the network management center to allow the signal to be provided to the third client.

7. The apparatus of claim 1 wherein the broadcast center provides the signal to a first client, the first client being capable of providing the signal to more than one client.

8. The apparatus of claim 1, wherein the broadcast center provides the signal to a plurality of clients, the plurality of clients being connected as at least one tree structure, the broadcast center providing the signal directly to each client that serves as the root of a tree structure.

9. The apparatus of claim 8, wherein the tree structure is divided into a plurality of IPP ranges.

10. The apparatus of claim 8, wherein the plurality of clients includes clients capable of transmitting the signal to a number of clients, the number being limited by at least one of the data transmission capacity and the processing capacity of each transmitting client.

11. The apparatus of claim 8, wherein each of the clients in the tree structure has joined the tree structure by communicating with the network management center.

12. The apparatus of claim 11, wherein communicating with the network management center includes:
a client sending a connection information request to the network management center; and
the network management center providing connection information to the client.

13. The apparatus of claim 11, wherein each client communicates with the network management center only while joining the tree structure, and does not communicate with the network management center after joining the tree structure.

14. The apparatus of claim 8, wherein the signal includes a main stream channel and a control channel.

15. The apparatus of claim 14, wherein when a client receives a control channel message via the control channel, if the control channel message includes a synchronous command, the client waits for a matching signal feature in the mainstream channel, whereupon the control channel message is passed to a control command processor for immediate processing.

16. The apparatus of claim 14, wherein when a client receives a control channel message via the control channel, if the control channel message includes an asynchronous command, the control channel message is passed to a control command processor for immediate processing.

17. The apparatus of claim 1, wherein the broadcast center receives content from a content provider, and uses the content to provide the signal.

18. The apparatus of claim 1, wherein the broadcast center provides an encrypted signal.

19. The apparatus of claim 1, wherein the signal is encrypted using private/public key encryption.

20. The apparatus of claim 19, wherein the public key is provided with the signal so-encrypted.

21. The apparatus of claim 18, wherein an authorized recipient client decrypts the signal to reveal the content, and also provides the encrypted signal to at least one other authorized recipient client.

22. The apparatus of claim 1, further including a key management center, cooperative with the broadcast center, the key management center including:
a channel key generator;
a channel key repository; and
a channel key distribution engine.

23. The apparatus of claim 22, wherein the broadcast center receives a channel key from the key management center, and uses the channel key to encrypt the signal to provide an encrypted signal.

24. The apparatus of claim 23, wherein an authorized recipient client receives a channel key from the key management center, and uses the channel key to decrypt the encrypted signal.

25. The apparatus of claim 24, wherein each authorized recipient client receives the channel key from the key management center.

26. The apparatus of claim 1, wherein the broadcast center encrypts the signal using a channel key to provide an encrypted signal, and the broadcast center uses a private key to provide a signed message hash.

27. The apparatus of claim 1, wherein an authorized recipient client receives the encrypted signal and the signed message hash, and uses a channel key to provide a decrypted signal, and uses the decrypted signal, the signed message hash, and a public key to determine whether message content of the decrypted signal is valid.

28. The apparatus of claim 8, wherein a client within a tree structure no longer receives a signal, but nevertheless provides a heart beat signal to a plurality of clients connected to the client, the heartbeat signal being used by the plurality of clients to remain connected to the client.

29. The apparatus of claim 14, wherein the main stream channel and the control channel are received by a client, the client including:
a display manager configured to provide user experience elements; and
a control command processor configured to provide display commands to the display manager,
the user experience elements being acted upon by a user.

30. The apparatus of claim 29, wherein the user options acted upon by a user result in a communication as defined in the user options.

31. A method for adding a client to a peer-to-peer network so as to add clients in a controlled manner, the method comprising:
receiving, at a network management center, a connection information request from a requesting client; and
sending, from the network management center, connection information to both the requesting client and a broadcasting client also as to facilitate communication between the broadcasting client and the requesting client, thereby adding the requesting client.

32. The method of claim 31, wherein communication between the broadcasting client and the requesting client includes:
sending a connection request from the requesting client to the broadcasting client; and
sending a signal from the broadcasting client to the requesting client.

33. The method of claim 32, wherein the signal is at least one of a data stream and a data file.

34. The method of claim 32, wherein the signal is any information.
